(19) United States
(12) Patent Application Publication
(10) Pub. No.: US 2026/0314569 A1
(43) Pub. Date: Oct. 15, 2026

(54) Beehive Winterization Device

(71) Applicant: John Prinkey, Meadville, PA (US)

(72) Inventor: John Prinkey, Meadville, PA (US)

(21) Appl. No.: 19/400,273

(22) Filed: Nov. 25, 2025

Related U.S. Application Data
(60) Provisional application No. 63/787,035, filed on Apr. 11, 2025.

(51) Int. Cl. A01K 47/06

(52) U.S. Cl. CPC A01K 47/06

(57) ABSTRACT

A beehive winterization device is provided. The device is comprised of a thermally insulated body configured to be inserted within a standard beehive assembly. The body comprises four vertically oriented side walls, each having an inner surface affixed with insulating materials. The side walls define an interior space configured to receive multiple vertically oriented honey frames. The device further comprises a top insulation panel positioned horizontally or nearly horizontally above the honey frames that is made from high-resistance thermal materials. Angled insulation panels are further positioned to opposing side walls forming an A-shaped sub-cavity within the interior space, designed to concentrate bee activity and enhance thermal retention. These angled panels also facilitate passive airflow and deflect moisture away from the bee cluster. The top and angled insulation panels may include one or more access ports equipped with removable insulated caps, enabling the non-disruptive delivery of supplemental feeding.

### CROSS-REFERENCE TO RELATED APPLICATION

The present application claims priority to, and the benefit of, U.S. Provisional Application No. 63/787,035, which was filed on Apr. 11, 2025, and is incorporated herein by reference in its entirety.

### FIELD OF THE INVENTION

The present invention relates generally to the field of beekeeping. More specifically, the present invention relates to a thermally insulated insert for standard beehives having a top insulation panel and angled insulation panels that together define an interior space for housing honey frames that retains heat, promotes airflow, directs bee activity, and deflects moisture. Accordingly, the present disclosure makes specific reference thereto. Nonetheless, it is to be appreciated that aspects of the present invention are also equally applicable to other like applications, devices, and methods of manufacture.

### BACKGROUND

Beekeeping in colder climates presents numerous seasonal challenges, particularly during the winter months when honeybee colonies are vulnerable to both environmental and resource-related stresses. Winter conditions can cause bees to freeze or starve due to insufficient insulation, poor access to stored food, and excessive moisture accumulation within the hive. Traditional methods of winterization often lack adequate thermal retention and fail to maintain proper ventilation, which can result in lethal conditions for the colony. Moisture buildup is especially problematic, as condensation can form on the interior surfaces of the hive and drip onto bees, leading to hypothermia. Moreover, accessing the hive to provide additional nourishment without disturbing the bees can be both invasive and inefficient, exacerbating the risks. Conventional solutions also do not account for optimizing internal airflow and do not promote efficient heat retention or resource guidance. Beekeepers often face significant colony losses in winter due to the limitations of current practices and technologies. As such, an improved and non-disruptive solution is required to ensure honeybee survival throughout the cold season while maintaining hive integrity.

Therefore, there exists a long-felt need in the art for a beehive winterization device that enables effective thermal insulation and moisture control during winter months. There also exists a long-felt need in the art for a beehive winterization device that allows honeybees to access stored nourishment and facilitates targeted bee movement. Moreover, there exists a long-felt need in the art for a beehive winterization device that permits beekeepers to supply supplemental feeding without compromising the internal environment of the hive.

The subject matter disclosed and claimed herein, in one embodiment thereof, comprises a beehive winterization device. The device is comprised of a thermally insulated body configured to be inserted within a standard beehive assembly. The body comprises four vertically oriented side walls, each having an inner surface affixed with insulating materials. The side walls define an interior space configured to receive multiple vertically oriented honey frames, which may be retained in position by integrated structural features such as grooves, brackets, or ledges. The device further comprises a top insulation panel positioned horizontally or nearly horizontally above the honey frames that is made from high-resistance thermal materials. Angled insulation panels are further positioned to opposing side walls forming an A-shaped sub-cavity within the interior space, designed to concentrate bee activity and enhance thermal retention. These angled panels also facilitate passive airflow and deflect moisture away from the bee cluster. The top and angled insulation panels may include one or more access ports equipped with removable insulated caps, enabling the non-disruptive delivery of supplemental feeding through syringes or nozzles.

In this manner, the beehive winterization device of the present invention accomplishes all the foregoing objectives and provides a thermally insulated beehive enclosure that minimizes heat loss and moisture accumulation during winter. The integrated sub-cavity formed by angled insulation panels enhances thermal efficiency and directs bees toward centrally located resources, reducing starvation risks. Optional access ports allow for supplemental feeding without exposing the hive to cold air or disrupting its internal conditions. By addressing insulation, ventilation, condensation management, and nourishment delivery, the beehive winterization device offers a comprehensive solution to the seasonal challenges encountered by beekeepers.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a beehive winterization device. The device is comprised of a body defined by four vertically oriented side walls. Each side wall includes an inner surface with attached insulating material affixed through bonding, fasteners, or molded interlocks. The side walls collectively define an interior space that is configured to hold a plurality of vertically oriented honey frames in a parallel arrangement. In one embodiment, the frames are supported by retention features integrated into the inner surfaces of the side walls. Each honey frame is comprised of a frame body that includes a foundation layer for comb construction. The frame body includes a top member that may be comprised of lifting notches, a bottom member, and two side members.

The interior space further includes a top insulation panel positioned horizontally or near-horizontally. The panel is formed from thermally resistant materials and may rest directly on or be suspended above the top frame members using support elements. Two angled insulation panels are also included and may be affixed along opposing side walls and forming an angle relative to the horizontal axis of the top insulation panel. The angled panels define an internal A-shaped sub-cavity designed to direct bee movement, reduce cold exposure, and improve heat retention. The sub-cavity supports enhanced winterization by concentrating colony activity within a reduced, insulated volume, facilitating thermoregulation and moisture control. The angled panels additionally serve to deflect condensation and promote airflow to reduce dampness. In one embodiment, at least one access port is integrated into the insulation panels, allowing nutrient delivery without disrupting the thermal barrier. In a further embodiment, each port includes a removable insulated cap to preserve insulation when closed and permit feeding through various tools when open.

Accordingly, the beehive winterization device of the present invention is particularly advantageous as it provides a thermally insulated beehive enclosure that minimizes heat loss and moisture accumulation during winter. The integrated sub-cavity formed by angled insulation panels enhances thermal efficiency and directs bees toward centrally located resources, reducing starvation risks. Optional access ports allow for supplemental feeding without exposing the hive to cold air or disrupting its internal conditions. By addressing insulation, ventilation, condensation management, and nourishment delivery, the beehive winterization device offers a comprehensive solution to the seasonal challenges encountered by beekeepers that overcomes the limitations of existing devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side cross-sectional view of one potential embodiment of a beehive winterization device of the present invention in accordance with the disclosed architecture;

FIG. 2 illustrates a top perspective view of one potential embodiment of a beehive winterization device of the present invention in accordance with the disclosed architecture; and

FIG. 3 illustrates a side view of a honey frame of one potential embodiment of a beehive winterization device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a beehive winterization device that enables effective thermal insulation and moisture control during winter months. There also exists a long-felt need in the art for a beehive winterization device that allows honeybees to access stored nourishment and facilitates targeted bee movement. Moreover, there exists a long-felt need in the art for a beehive winterization device that permits beekeepers to supply supplemental feeding without compromising the internal environment of the hive.

The present invention, in one exemplary embodiment, is comprised of a beehive winterization device. The device includes a body formed by four vertically oriented side walls. Each side wall features an inner surface to which insulating material is attached using bonding methods, mechanical fasteners, or molded interlocks. Together, the side walls define an interior space designed to accommodate a plurality of honey frames arranged vertically and in parallel. In one embodiment, the honey frames are retained by structural features integrated into the inner surfaces of the side walls. Each honey frame includes a frame body incorporating a foundation layer intended for comb construction. The frame body comprises a top member with lifting notches, a bottom member, and two side members.

The interior space is further provided with a top insulation panel positioned horizontally or nearly horizontally. The top panel is made from thermally resistant materials and may either rest directly on or be suspended above the top members of the honey frames using support elements. Additionally, two angled insulation panels may be affixed to opposing side walls, forming an angle relative to the horizontal plane of the top insulation panel. The angled panels define an internal A-shaped sub-cavity that directs bee movement, reduces cold exposure, and enhances heat retention. This sub-cavity facilitates effective winterization by concentrating bee activity within a smaller, insulated volume, supporting thermoregulation and limiting moisture accumulation. The angled panels also function to deflect condensation and support airflow for internal humidity control.

In one embodiment, at least one access port is incorporated into the insulation panels to permit nutrient delivery without compromising the thermal barrier. In a further embodiment, each access port is sealed with a removable insulated cap that maintains insulation when closed and permits feeding via syringes, nozzles, or containers when open.

As a result, the beehive winterization device provides a thermally insulated enclosure that minimizes both heat loss and moisture buildup during winter conditions. The integrated sub-cavity formed by the angled insulation panels improves thermal performance and encourages bees to cluster near centralized resources, thereby reducing starvation risk. Optional access ports further enable supplemental feeding without exposing the hive to cold air or disturbing internal conditions. Accordingly, through integrated insulation, ventilation, moisture management, and feeding access, the device delivers a complete solution to the seasonal challenges faced by beekeepers, surpassing the limitations of conventional devices and methods.

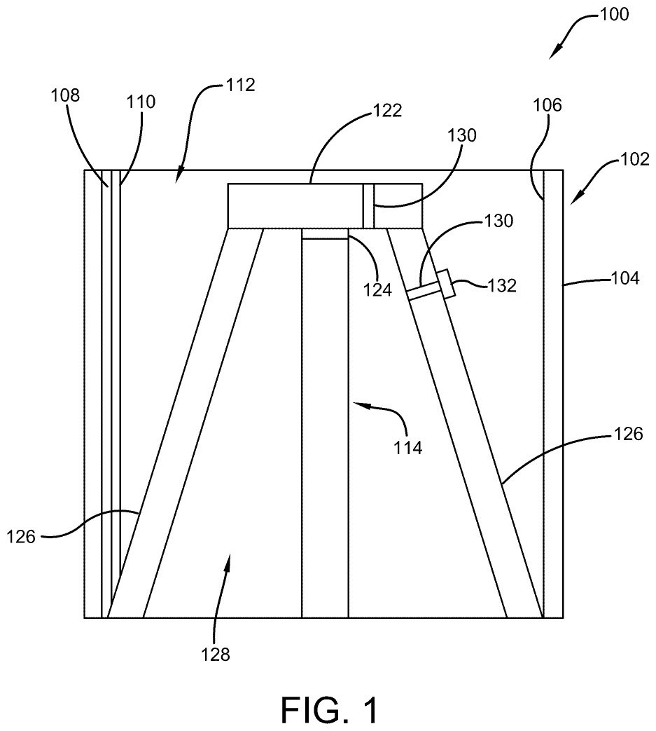

Referring initially to the drawings, FIG. 1 illustrates a side cross-sectional view of one potential embodiment of a beehive winterization device 100 of the present invention in accordance with the disclosed architecture. The device 100 is comprised of a body 102. The body 102 may be any geometric shape, but is preferably defined by four vertically oriented side walls 104. Each side wall 104 may be comprised of an inner surface 106 having an attached insulating material 108 such as, but not limited to, foam board, cork, wool composite, reflective foil-laminated panels, etc. The insulating material 108 may be affixed to the inner surface 106 through fasteners 110 such as, but not limited to, adhesive bonding, mechanical retention fasteners, or integrally molded mechanical interlocks.

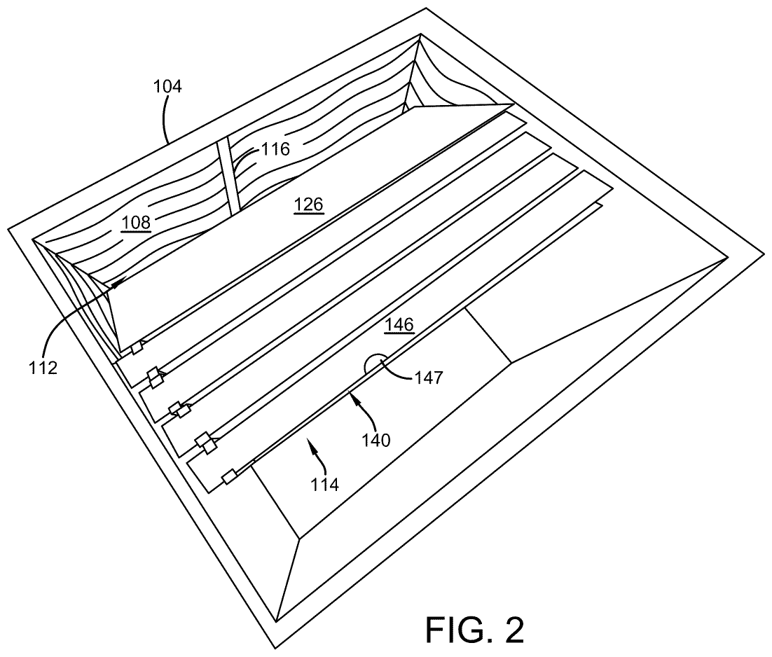

The side walls 104 may collectively define an interior space 112, as seen in FIG. 1 and FIG. 2. The interior space 112 may accommodate a plurality of honey frames 114 that are vertically oriented and spaced in a parallel configuration. The honey frames 114 may be received and supported by retention features 116 integrated into the inner surfaces 106 in one embodiment. The structural retention features 116 may include, but are not limited to, longitudinal channels, grooves, inward-projecting ledges, edge tracks, or embedded brackets configured to align and stabilize the vertical orientation of the honey frames 114 under both static and vibrational loading conditions.

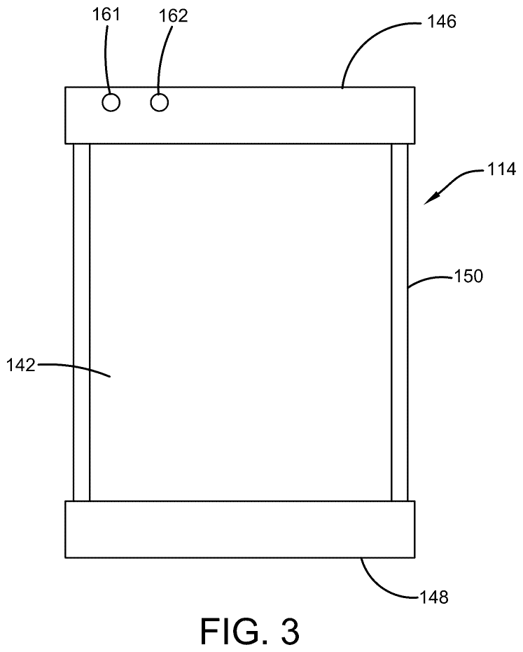

The honey frames 114 positioned within the interior space 112 may each be comprised of a frame body 140 having a foundation layer 142, as seen in FIG. 3, which may serve as the initial substrate upon which bees construct wax comb. The foundation layer 142 may be comprised of materials such as, but not limited to, beeswax, wax-coated plastic, molded polymer sheets, or stamped metal mesh. More specifically, the frame body 140 may be comprised of a top frame member 146, a bottom frame member 148, and two side frame member 150. The top frame member 146 may be configured with recesses/notches 147 for easy lifting of the frame 114 out of the interior space 112. In certain configurations, the frame body 140 may be treated with hydrophobic coatings 161 or antimicrobial coatings 162 to resist fungal growth and promote long-term durability within the humid microenvironment of the hive.

The interior space 112 is further comprised of a top insulation panel 122 that may be horizontally or near-horizontally oriented, as seen in FIG. 1. The top insulation panel 122 may be made from materials exhibiting high thermal resistance such as, but not limited to, expanded polystyrene, extruded closed-cell foam, polyisocyanurate board, wood-fiber panels, foam board, cork, wool composite, reflective foil-laminated panels, etc. The top insulation panel 122 may be supported by resting directly upon the top frame member 146 or suspended slightly above the top frame member 146 by support elements 124 such as, but not limited to, screws, clips, tabs, retention brackets, etc.

To enhance thermal management and regulate internal airflow, the interior space 112 may additionally be comprised of two angled insulation panels 126, as seen in FIG. 1 and FIG. 2, made from the same or differing material as the top insulation panel 122. Each angled insulation panel 126 may be affixed along opposing side walls 104 and may form an angle between 1 and 89 degrees relative to a horizontal axis of the top insulation panel 122. The angular configuration of the panels 126 may generate an internal, generally A-shaped sub-cavity 128 within the interior space 112. This sub-cavity 128 may direct honeybee movement toward the frames 114 and may establish a thermally stabilized microenvironment that reduces cold air exposure and improves heat retention.

The sub-cavity 128 defined by the angular geometry of the top insulation panel 122 and angled insulation panels 126 (as seen in FIG. 1) may facilitate improved winterization by concentrating colony activity within a reduced and insulated thermal volume. This spatial configuration may support more efficient thermoregulation by the honeybee cluster and may inhibit the accumulation of internal moisture. The angled insulation panels 126 may also function as condensation deflectors, directing moisture away from the bee cluster and supporting passive airflow pathways to mitigate internal dampness and condensation.

In one embodiment, the panels 122, 126 may be comprised of at least one access port 130, as seen in FIG. 1. Each access port 130 may allow beekeepers to deliver supplemental nourishment such as syrup or fondant without disturbing the thermal barrier established by the insulation panels. Each access port 130 may be comprised of a removable insulated cap 132, which may maintain the insulating properties of each panel 122, 126 when closed and may be temporarily removed to permit nutrient insertion via a nozzle, syringe, or feed container.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “beehive winterization device” and “device” are interchangeable and refer to the beehive winterization device 100 of the present invention.

Notwithstanding the foregoing, the beehive winterization device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the beehive winterization device 100 as shown in the FIGS. are for illustrative purposes only, and that many other sizes and shapes of the beehive winterization device 100 are well within the scope of the present disclosure. Although the dimensions of the beehive winterization device 100 are important design parameters for user convenience, the beehive winterization device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A beehive winterization device comprising:
a body defined by a plurality of vertically oriented side walls having an inner surface having an attached insulating material, wherein the side walls collectively define an interior space;
a honey frame vertically within the interior space;
a top insulation panel oriented within the interior space above the honey frame; and
an angled insulation panel forming an angle between 1 and 89 degrees relative to a horizontal axis of the top insulation panel and defining a sub-cavity within the interior space.

2. The beehive winterization device of claim 1, wherein the insulating material is comprised of a foam board, a cork, a wool composite, or a reflective foil-laminated panel.

3. The beehive winterization device of claim 1, wherein the inner surface is comprised of a retention feature that receives the honey frame.

4. The beehive winterization device of claim 1, wherein the honey frame is comprised of a foundation layer.

5. The beehive winterization device of claim 1, wherein the honey frame is comprised of a top frame member comprised of a recess or a notch.

6. The beehive winterization device of claim 1, wherein the honey frame is comprised of a hydrophobic coating.

7. The beehive winterization device of claim 1, wherein the honey frame is comprised of an antimicrobial coating.

8. A beehive winterization device comprising:
a body defined by a plurality of vertically oriented side walls having an inner surface having an attached insulating material, wherein the side walls collectively define an interior space;
a honey frame vertically within the interior space;
an access port;
a top insulation panel oriented within the interior space above the honey frame; and
an angled insulation panel forming an angle between 1 and 89 degrees relative to a horizontal axis of the top insulation panel and defining a sub-cavity within the interior space.

9. The beehive winterization device of claim 8, wherein the top insulation panel and the angled insulation panel is comprised of an expanded polystyrene, an extruded closed-cell foam, a polyisocyanurate board, a wood-fiber panel, a foam board, a cork, a wool composite, or a reflective foil-laminated panel.

10. The beehive winterization device of claim 8, wherein the inner surface is comprised of a retention feature that receives the honey frame.

11. The beehive winterization device of claim 8, wherein the honey frame is comprised of a foundation layer.

12. The beehive winterization device of claim 8, wherein the honey frame is comprised of a top frame member comprised of a recessed or a notch.

13. The beehive winterization device of claim 8, wherein the honey frame is comprised of a hydrophobic coating.

14. The beehive winterization device of claim 8, wherein the honey frame is comprised of an antimicrobial coating.

15. A beehive winterization device comprising:
a body defined by a plurality of vertically oriented side walls having an inner surface having an attached insulating material, wherein the side walls collectively define an interior space;
a honey frame vertically within the interior space;
an access port;
an insulated cap;
a top insulation panel oriented within the interior space above the honey frame; and
an angled insulation panel forming an angle between 1 and 89 degrees relative to a horizontal axis of the top insulation panel and defining a sub-cavity within the interior space.

16. The beehive winterization device of claim 15, wherein the top insulation panel and the angled insulation panel is comprised of an expanded polystyrene, an extruded closed-cell foam, a polyisocyanurate board, a wood-fiber panel, a foam board, a cork, a wool composite, or a reflective foil-laminated panel.

17. The beehive winterization device of claim 15, wherein the inner surface is comprised of a retention feature that receives the honey frame.

18. The beehive winterization device of claim 15, wherein the honey frame is comprised of a foundation layer.

19. The beehive winterization device of claim 15, wherein the honey frame is comprised of a top frame member comprised of a recessed or a notch.

20. The beehive winterization device of claim 15, wherein the honey frame is comprised of a hydrophobic coating.
